(19) United States
(12) Patent Application Publication
(10) Pub. No.: US 2024/0416767 A1
(43) Pub. Date: Dec. 19, 2024

(54) GROUND-PAD MODULE WITH SENSOR ARRANGEMENT

(71) Applicant: BRUSA Elektronik AG, Buchs (CH)

(72) Inventors: Stefan Schwertner, Buchs (CH); Paolo Lombardo, Buchs (CH); Simon Islinger, Buchs (CH); Lukas Böhler, Buchs (CH)

(21) Appl. No.: 18/700,371

(22) PCT Filed: Oct. 12, 2022
(86) PCT No.: PCT/EP2022/078413

§ 371 Date: Apr. 11, 2024

(30) Foreign Application Priority Data
Oct. 15, 2021 (DE) 10 2021 126 770.6

(51) Int. Cl. B60L 53/122; B60L 53/124

(52) U.S. Cl. CPC B60L 53/122; B60L 53/124

(57) ABSTRACT

A ground-pad module (GPM) for wirelessly charging a battery in an electric vehicle. The GPM includes a power emission device that is configured to provide electric power to a car-pad module (CPM) provided by the electric vehicle and configured to charge the battery. The GPM inductively transmits electric power from the GPM to the CPM, and a sensor arrangement for detecting at least one of objects made at least partly from metal, living objects, and a relative positioning between the CPM and the GPM. The sensor arrangement is configured to conduct at least one of a sensing current, a measuring-induced current, and voltage. The sensor arrangement includes a foil as base substrate, a plurality of sensors and connection cables printed on the foil, which sensors are configured to provide object detection.

### FIELD OF THE INVENTION

The present invention relates to a ground-pad module for wirelessly charging a battery of an electric vehicle.

### BACKGROUND OF THE INVENTION

Alternating current (AC) charging of electric vehicles is very important for residential areas and semipublic/public urban areas. Typical AC chargers are capable of providing charging power of up to 22 kW. AC charging systems can be divided into wired charging system and wireless charging systems, wherein wireless charging systems are mainly embodied as inductive charging systems (ICS). Inductive charging systems typically comprise two separate modules which are often referred to as ground-pad module (GPM) and car-pad module (CPM). The ground-pad module is installed outside the electric vehicle while the car-pad module is installed in the electric vehicle. Electromagnetic interaction between ground-pad module and car-pad module enables energy transfer from the ground-pad module to the car-pad module, and the car-pad module is in turn used for charging a battery of the electric vehicle. Wireless charging systems are often more convenient for a user as typically no manual intervention of the driver is required for starting the charging process of the battery. Wired charging systems on the other hand require the user to connect the electric vehicle to a utility grid using a cable.

In case other objects, in particular metal objects or humans, are close to the ground-pad module or the car-pad module during wireless charging, a risk of heating/burning exists. Inductive charging systems are therefore typically equipped with object detection means, in particular metal object and/or living object detection means, for detecting objects close to the ground-pad module or the car-pad module. If an object is detected, the wireless charging can be stopped. In state-of-the-art ground pad modules, such object detection is often done using field-based detection methods in which a variation of inductance, resistance or capacitance (or derived quantities) is used to detect the presence of an object. Field-based detection methods may be divided into inductive object detection methods and capacitive object detection methods. Inductive object detection methods are based on detecting variation of inductance due to the presence of a foreign object close to the ground-pad module/car-pad module. Inductive object detection is typically provided by a detection coil array which is placed above a transmitter of the ground-pad module. Capacitive object detection methods are based on detecting variation of capacitance due to the presence of a foreign object close to the ground-pad module/car-pad module.

State-of-the-art inductive object detection methods can be divided into passive inductive detection methods and active inductive detection methods. Passive inductive detection methods use the magnetic field created by the ground-pad module for power transfer to the car-pad module. This magnetic field induces voltages in the object detection arrays, and changes to the magnetic field due to foreign objects are reflected in changes of the induced voltages. In active inductive detection methods on the other hand a detection field is generated by the detection array, and changes to the field due to metal objects/living objects are detected. State-of-the-art detection arrays are provided on printed circuit boards (PCBs).

### OBJECT OF THE INVENTION

It is therefore an objective of the present invention to provide a ground-pad module with an sensor arrangement for detecting metal objects/living objects close to the ground-pad module or to a corresponding car-pad module.

This objective is achieved by realizing the characterizing features of the independent claim. Features which further develop the invention in an alternative or advantageous manner are described in the dependent patent claims.

### SUMMARY OF THE INVENTION

The invention relates to a ground-pad module (GPM) for wirelessly charging a battery in an electric vehicle, the GPM comprising power emission means, in particular embodied as a coil, which power emission means are configured to provide electric power to a car-pad module (CPM) comprised by the electric vehicle and configured to charge the battery, wherein the GPM is configured to inductively transmit electric power from the GPM to the CPM, and an sensor arrangement, in particular for detecting at least one of objects made at least partly from metal, living objects, and a relative positioning between the CPM and the GPM, said sensor arrangement configured for conducting at least one of a sensing current, a measuring-induced current, and voltage, wherein the sensor arrangement comprises a foil as base substrate, in particular as isolating flexible substrate, a plurality of sensors and connection cables printed on the foil, which sensors are configured to provide object detection, in particular using screen printing of electrically conductive ink, in particular at least one of silver ink and copper ink.

A sensor arrangement realized on a foil is more flexible and requires less construction effort than state-of-the-art sensor arrangements realized on PCBs. A sensor arrangement on a foil can therefore be better integrated into a ground-pad module, as the flexibility of e.g. a PET or Kapton foil allows a more flexible placement of such an inventive sensor arrangement compared to state-of-the-art sensor arrangements. Silver ink may be electrically beneficial due to a very good conductivity. The temperature “dependency” of the flexible loop array has a great advantage with silver ink. Commercial silver ink has a temperature coefficient of 0.0543Ω/° C. (see: www.mdpi.com/2076-3417/8/11/2101/pdf), wherein copper has a temperature coefficient of 0.004041Ω/° C. (see: www.allaboutcircuits.com/textbook/direct-current/chpt-12/temperature-coefficient-resistance). In general, the sensor can be used to measure heated objects by increasing resistance. The higher temperature coefficient of the printed loop array adds sensitivity.

In some embodiments, the ground-pad module comprises a cover sheet, in particular embodied as a glass fiber cover sheet and in particular of rectangular form, wherein the foil is attached to the cover sheet, in particular by at least one of baking, pressing, and gluing.

The cover sheet may comprise the material GF70* which has beneficial temperature properties. The cover sheet may protect the ground-pad module from above, i.e. it may e.g. shield the power emission means from above in order to protect the power emission means, e.g. from a car which accidentally drives over the ground-pad module. The foil can be fixedly attached to the cover sheet, wherein fixed attachment can be provided by baking and pressing.

In some embodiments, the GPM comprises a further sensor arrangement having a further foil with a further plurality of sensors and further connection cables printed on the further foil, in particular by screen printing at least one of silver ink and copper ink, which further plurality of sensors are configured to provide object detection, wherein the further foil is attached to the cover sheet, in particular by at least one of baking, pressing, and gluing.

The ground-pad module may therefore comprise two separate sensor arrangements. Both sensor arrangements may provide the same functionality, being however realized on two separate foils, i.e. both may be used for detecting metal objects or living objects close to the ground-pad module or car-pad module.

In some embodiments, the foil comprises a connection strip, in particular an L-shaped connection strip, or respectively, the further foil comprises a further connection strip, in particular an L-shaped further connection strip, the plurality of sensors, or respectively the further plurality of sensors, is electrically connected to separate components of the GPM through the connection strip, or respectively the further connection strip, the connection cables, or respectively the further connection cables, are routed from the connection strip, or respectively the further connection strip, to the plurality of sensors or respectively the further plurality of sensors, and individual sensors of the plurality of sensors or of the further plurality of sensors can be accessed through the connection strip, or respectively through the further connection strip.

Such a connection strip may provide a compact interface for contacting the sensors of the sensor arrangement. The connection strip, and also the further connection strip, may be bent, thereby providing a flexible and compact interface at which the sensor arrangement and/or further sensor arrangement can be connected to other components of the ground-pad module.

In some embodiments, the connection strip and the further connection strip are detached from the cover sheet, wherein the foil and the further foil are arranged in such a way on the cover sheet that the connection strip is substantially arranged on the further foil and that the further connection strip is substantially arranged on the foil, wherein the connection strip and the further connection strip are bent away from the further foil, or respectively from the foil, in particular at substantially 90 degrees with respect to the cover sheet.

The connection strip and the further connection strip may therefore be movable even after the foil and the further foil are fixedly attached to the cover sheet.

In some embodiments, the connection strip and the further connection strip are laterally displaced to one another.

Lateral displacement may be understood to refer to the underlying geometry of the cover sheet. In case the cover sheet is e.g. rectangular, lateral displacement may refer to a displacement along at least one of the two directions corresponding to the edges of the cover sheet.

In some embodiments, at least one of the connection strip and the further connection strip is inserted into a reception slot of the separate components of the GPM, in particular into a reception slot of a PCB comprising at least one of a processing unit and a controlling unit.

Operation of the sensor arrangement may be synchronized with operation of the power emission means. In case a metal object or living object is detected close to the ground-pad module or car-pad module, operation of the power emission means may be automatically reduced or halted.

In some embodiments, at least one of the sensor arrangement and the further sensor arrangement are placed between the cover sheet and the power emission means.

In some embodiments, at least one of the sensor arrangement and the further sensor arrangement is placed on the opposite side of the cover sheet with respect to the power emission means, wherein the cover sheet comprises a hole through which at least one of the connection strip and the further connection strip pass.

An sensor arrangement printed on a foil may be flexible. In case such an sensor arrangement is placed on top of the cover sheet, a car which would accidentally drive over a ground-pad module comprising such an sensor arrangement would damage the overall ground-pad module less than in case the ground-pad module comprises a stiff PCB on which the sensor arrangement is realized, and which stiff PCB is arranged on top of the cover sheet. An sensor arrangement printed on a foil therefore offers a greater placement flexibility compared to state-of-the-art sensor arrangements.

In some embodiments, the cover sheet has a cover sheet spatial extent, and the foil and the further foil have a foil spatial extent and a further foil spatial extent respectively, wherein the ratio of foil spatial extent to cover sheet spatial extent, or foil spatial extent plus further foil spatial extent to cover sheet spatial extent, is smaller than 0.9, in particular smaller than 0.5.

The sensor arrangement(s) may therefore be smaller than the cover sheet. The size of the sensor arrangement(s) may therefore be matched to the size of the power emission means and the emission behavior of the power emission means.

In some embodiments, the power emitted by the power emission means is substantially emitted through an emission area, and the foil, or foil plus further foil, are at least as large as the emission area and are placed in the emission area.

The emission area may be a plane through which most of the transmitted electromagnetic energy from the ground-pad module to the car-pad module passes.

In some embodiments, at least one of the plurality of sensors and the further plurality of sensors are embodied as loop sensors and arranged in two-dimensional arrays on the foil, or respectively on the further foil.

In some embodiments, at least one of (a) the sensors and connection cables and (b) the further sensors and further connection cables are printed in layers on the foil, or respectively further foil, and at least one isolation layer is printed on the foil, or respectively at least one further isolation layer is printed on the further foil.

Isolation layers may be used to separate connection cables from each other, while gaps in isolation layers may e.g. be used for selectively connecting connection cables at specific points to each other.

In some embodiments, the GPM comprises a drive-over ramp, wherein the cover sheet is inserted on all sides into a recess of the drive-over ramp wherein the cover sheet is in particular attached to the drive-over ramp by a tongue-and-grooves attachment mechanism, and wherein the cover sheet is in particular non-planar and comprises a bent section close to the drive-over ramp.

The cover sheet may be planar in a central area in which the sensor arrangement is located, and be bent close to the drive-over ramp. Due to the flexibility of an sensor arrangement printed on a foil, such an sensor arrangement may also be placed on bent sections of the cover sheet, thereby providing greater installation flexibility and a greater detection area.

The invention further relates to a method of producing a GPM according to the description herein, said method comprising printing a plurality of sensors and connection cables on the foil, in particular using screen printing of electrically conductive ink, in particular at least one of silver ink and copper ink.

### BRIEF DESCRIPTION OF THE DRAWINGS

The inventive system is described below in more detail purely by way of example with the aid of concrete exemplary embodiments illustrated schematically in the drawings, further advantages of the invention also being examined. Identical elements are labelled with the same reference numerals in the figures. In detail:

FIG. 1 shows a schematic depiction of an sensor arrangement according to the invention;

FIG. 2 shows a further schematic depiction of an sensor arrangement according to the invention;

FIG. 3 shows a schematic depiction of a cover sheet to which an sensor arrangement and a further sensor arrangement according to the invention are attached;

FIG. 4a,b show schematic depictions of different possible placements of an sensor arrangement according to the invention on a cover sheet;

FIG. 5 shows a schematic depiction of a drive-over ramp with cover sheet on which an inventive sensor arrangement is attached;

FIG. 6 shows a schematic depiction of a connection mechanism with which the cover sheet is connected to a drive-over ramp;

FIG. 7a,b show schematic depictions of possible spatial arrangements of components of a ground-pad module; and

FIG. 8 shows a schematic depiction of a ground-pad module without an sensor arrangement and a cover sheet.

### DETAILED DESCRIPTION OF THE DRAWINGS

FIG. 1 shows a schematic depiction of an sensor arrangement 3′ according to the invention, in particular for detecting metal objects and/or living object, which sensor arrangement 3′ is part of a ground-pad module for wirelessly charging batteries of electric vehicles.

The sensor arrangement 3′ comprises a foil 4′, and a plurality of sensors 5′ and connection cables 6′ which are printed on the foil 4′, in particular using screen printing with silver ink and/or copper ink. The foil 4′ may e.g. be embodied as PET foil or as Kapton foil. The foil 4′ may be more flexible and elastic than state-of-the-art PCBs. An electric vehicle which accidently drives over of the foil 4′ would therefore damage it less than in case it would drive over a state-of-the-art PCB with included detection arrays.

The sensors 5′ of FIG. 1 are rectangular sensors and are arranged in a two-dimensional array pattern. Each sensor 5′ is connected by connection cables 6′ to a connection strip 8′, which connection strip 8′ provides an interface to connect the sensor arrangement 3′ to other components of the ground-pad module, in particular to a control and/or processing unit. Each sensor 5′ may register changes in magnetic fields due to the presence of foreign objects, in particular metal objects or living objects. Individual connection cables 6′ may be separated from each other using isolation layers between connection cables 6′.

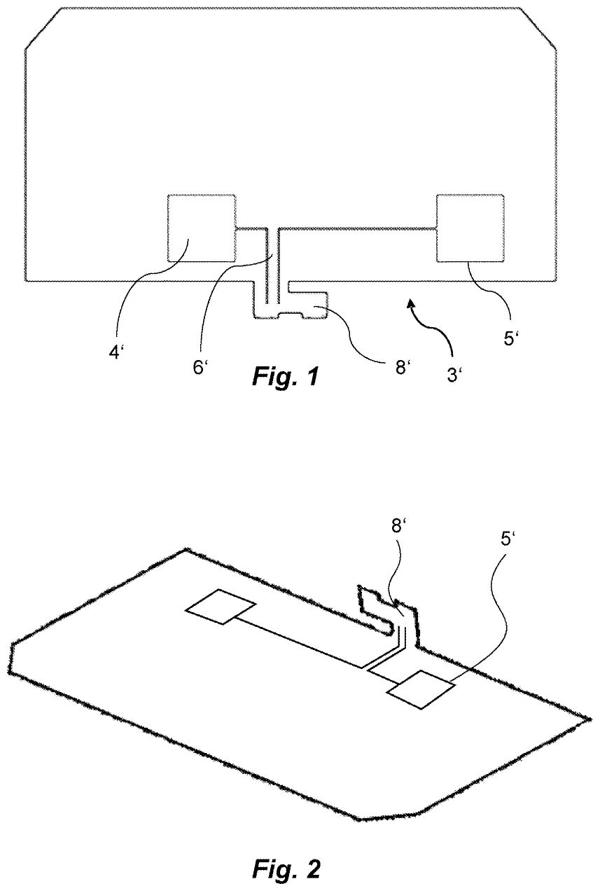

FIG. 2 shows a schematic depiction of an sensor arrangement 3′ according to the invention. In FIG. 2, the rectangular array of sensors 5′ is shown as well as the connection strip 8′. The connection strip 8′ is embodied as an L-shaped connection strip, wherein the connection strip 8′ is such that it can be bent, wherein after bending the connection strip 8′ is in particular orthogonal to the foil 4′ as shown in FIG. 2.

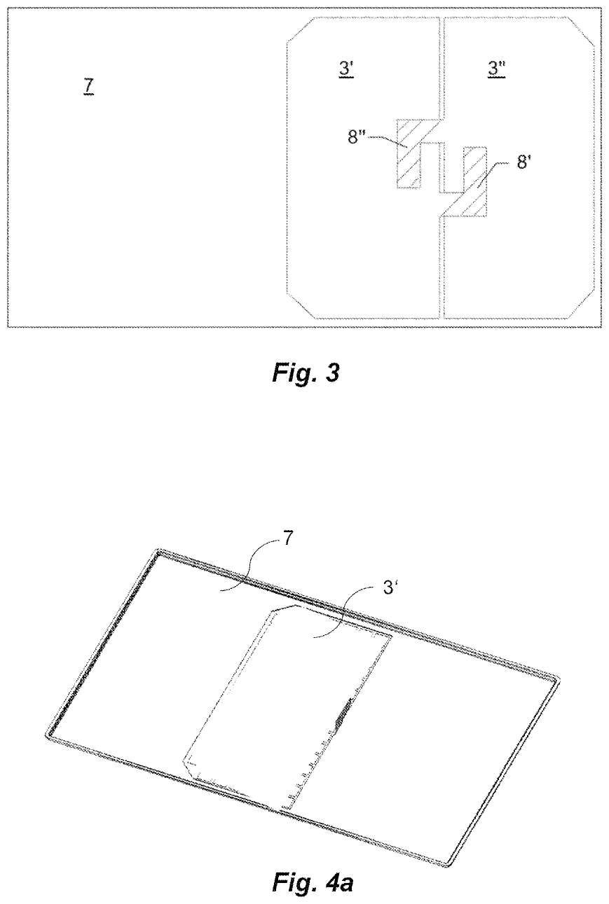

FIG. 3 shows a schematic depiction of a cover sheet 7 to which an sensor arrangement 3′ and a further sensor arrangement 3″ are attached. The cover sheet 7 is larger than the sensor arrangement 3′ and the further sensor arrangement 3″ together. The sensor arrangement 3′ and the further sensor arrangement 3″ may be attached as follows to the cover sheet 7: the foils 4′,4″ are placed in such a way on the cover sheet 7 that the L-shaped connection strip 8′ of the sensor arrangement 3′ lies on the further foil 4″ of the further sensor arrangement 3″ and that the L-shaped further connection strip 8″ of the further sensor arrangement 3″ lies on the foil 4′ of the sensor arrangement 3′. Through a baking process the foil 4′ and the further foil 4″ can be attached to the cover sheet 7, and the connection strip 8′ and the further connection strip 8″ are not attached to the cover sheet 7 after baking as they do not touch the cover sheet 7. After baking, the connection strip 8′ and the further connection strip 8″ can be bent, e.g. in such a way that the connection strip 8′ and the further connection strip 8″ are orthogonal to the cover sheet 7. The sensor arrangement 3′ and the further sensor arrangement 3″ may provide the same detection functionality.

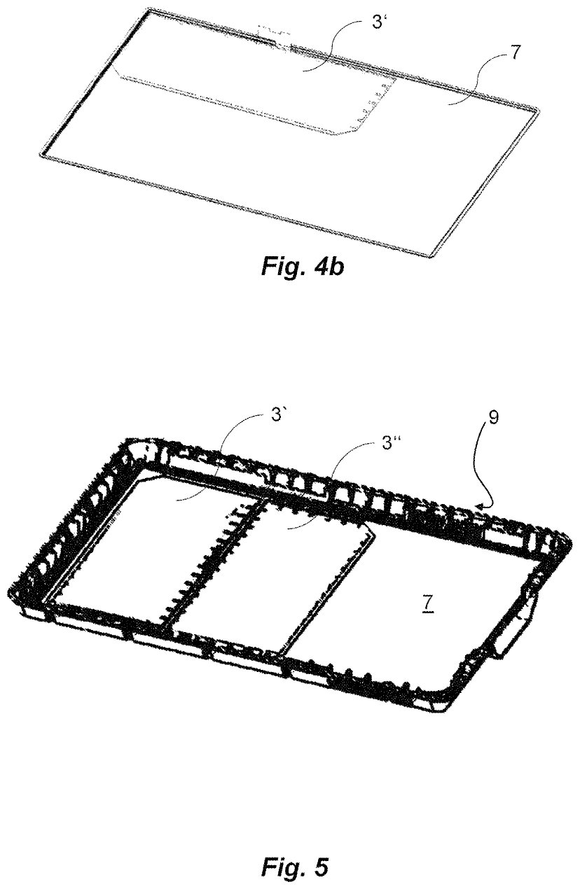

FIGS. 4a and 4b schematically show different possible placements of an sensor arrangement 3′ on a cover sheet 7. Other placements are feasible as well, particularly in combination with a further sensor arrangement 3″ (not shown in FIGS. 4a and 4b). The sensor arrangement 3′ may be placed in such a way on the cover sheet 7 so that it covers an emission area of power emission means used for transmitting power from a ground-pad module to a car-pad module. The emission area may be an area through which most of the transmitted power passes. The sensor arrangement 3′, or sensor arrangement 3′ and further sensor arrangement 3″, also may be larger than the emission area. The sensor arrangement 3′ may be placed in such a way on the cover sheet 7 so that it is spatially aligned with power emission means of the ground-pad module.

FIG. 5 schematically shows a drive-over ramp 9 to which a cover sheet 7 is attached, and on which an sensor arrangement 3′ and a further sensor arrangement 3″ are fixedly arranged. The connection strip and the further connection strip are bent away from the cover sheet 7, and have an angle of roughly 90 degrees with respect to the cover sheet. FIG. 5 shows the drive-over ramp 9 from below, i.e. from the side which faces the ground once the ground-pad module is installed towards the side facing away from the ground.

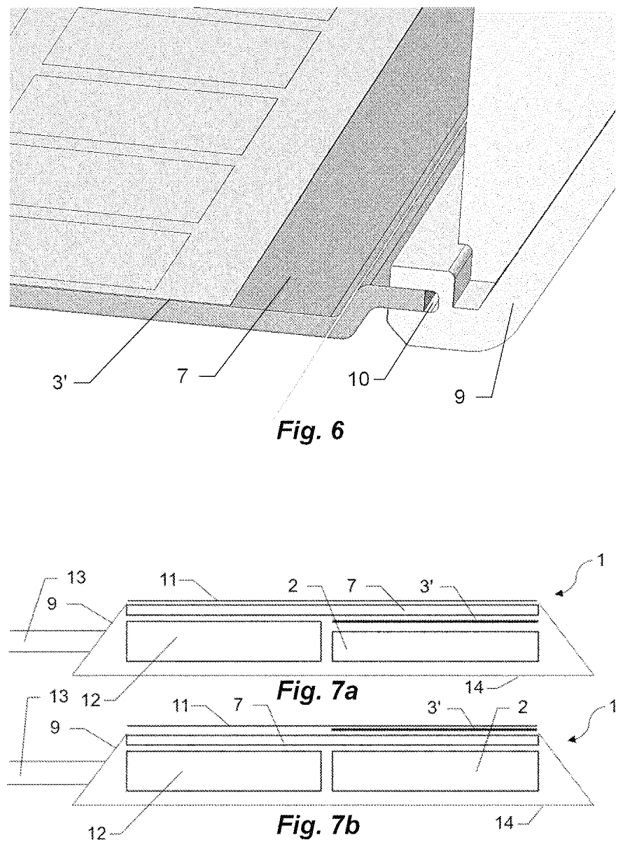

FIG. 6 schematically shows a connection mechanism connecting the cover sheet 7 to the drive-over ramp 9. The cover sheet 7 may be connected to the drive-over ramp 9 by a tongue-and-groove attachment mechanism. The drive-over ramp 9 may comprise a recess 10 into which the cover sheet 7 may be inserted, wherein a part of the cover sheet 7 which is inserted into the recess 10 may be contacted on at least two side by the drive-over ramp 9. The cover sheet 7 itself may be bent in such a way that the part of the cover sheet 7 on which the sensor arrangement 3′ is arranged is flush-mount with respect to an end of the drive-over ramp 9. The cover sheet 7 may be attached on all its sides by such an attachment mechanism to the drive-over ramp 9. An inventive sensor arrangement 3′ may alternatively also be placed on the bent part of the cover sheet 7. State-of-the-art sensor arrangements realized on PCBs may be difficult to place on a bent part of the cover sheet 7, while an sensor arrangement 3′ realized on a flexible foil may be more easily placed on bent sections of the cover sheet 7.

FIGS. 7a and 7b schematically show possible spatial arrangements of components of a ground-pad module 1 shown from a frontal view. An external connection 13 to the ground-pad module 1 may be used to connect the ground-pad module 1 to a utility grid from which electric power can be drawn. The ground-pad module 1 of FIGS. 7a and 7b comprises a drive-over ramp 9 on all its sides and a ground cover 14 which may seal the ground-pad module 1 from below. Drive-over ramp 9 and ground cover 14 may be connected. The ground-pad module 1 comprises power emissions means 2, in particular embodied as a coil for sending out electromagnetic radiation as well as necessary electronics for controlling emission of electromagnetic radiation. Other components 12 of the ground-pad module 1, which other components 12 may only indirectly be involved in the process of power emission, in particular equipment for cooling the ground-pad module, may be placed separately from the power emission means 2 in the ground-pad module 1. The sensor arrangement 3′ may be placed above the power emission means 2 and may e.g. be larger or equal to in size to the power emission means 2. The sensor arrangement 3′ may be placed below (FIG. 7a) or above (FIG. 7b) of a cover sheet 7, and the cover sheet 7 may fully cover the ground-pad module 1 from above. In case the sensor arrangement 3′ is placed above the cover sheet 7, the cover sheet 7 may comprise an opening through which a connection strip of the sensor arrangement 3′ is guided. On top of the cover sheet 7 (FIG. 7a) or on top of cover sheet 7 and sensor arrangement 3′ a design foil 11 may be placed. An inventive sensor arrangement 3′ may therefore be positioned at different locations in a ground-pad module 1 due to its flexible behavior as a result of it being realized on a flexible foil.

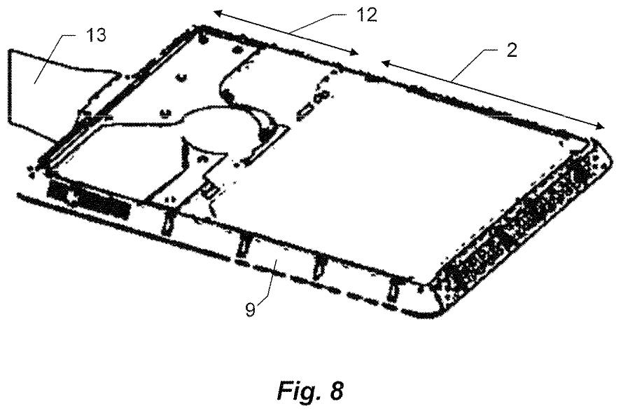

FIG. 8 schematically shows a ground-pad module 1 without an inventive sensor arrangement 3′ and without cover sheet 7. The ground-pad module 1 may comprise an external connection 13 through which it may receive electric power from a utility grid, power emission means 2 and other components 12, e.g. components for cooling the ground-pad module 1, as well as drive-over ramps 9. A sensor arrangement 3′ according to the invention is placed above the power emission means 2, while a cover sheet 7 is placed above both the power emission means 2 and the other components 12 of the ground-pad module 1.

It goes without saying that these figures illustrated are merely schematics of possible exemplary embodiments.

Although the invention is illustrated above, partly with reference to some preferred embodiments, it must be understood that numerous modifications and combinations of different features of the embodiments can be made. All of these modifications lie within the scope of the appended claims.

1. A ground-pad module (GPM) for wirelessly charging a battery in an electric vehicle, the GPM comprising:
power emission means, in particular embodied as a coil, which power emission means are configured to provide electric power to a car-pad module (CPM) comprised by the electric vehicle and configured to charge the battery, wherein the GPM is configured to inductively transmit electric power from the GPM to the CPM, and
an sensor arrangement, in particular for detecting at least one of objects made at least partly from metal, living objects, and a relative positioning between the CPM and the GPM, said sensor arrangement configured for conducting at least one of a sensing current, a measuring-induced current, and voltage,
wherein the sensor arrangement comprises:
a foil as base substrate, in particular as isolating flexible substrate,
a plurality of sensors and connection cables printed on the foil, which sensors are configured to provide object detection, in particular using screen printing of electrically conductive ink, in particular at least one of silver ink and copper ink.

2. The GPM according to claim 1,
characterized by a cover sheet, in particular embodied as a glass fiber cover sheet and in particular of rectangular form, wherein the foil is attached to the cover sheet, in particular by at least one of baking, pressing, and gluing.

3. The GPM according to claim 2,
characterized in that the GPM comprises a further sensor arrangement having a further foil with a further plurality of sensors and further connection cables printed on the further foil, in particular by screen printing at least one of silver ink and copper ink, which further plurality of sensors are configured to provide object detection, wherein the further foil is attached to the cover sheet, in particular by at least one of baking, pressing, and gluing.

4. The GPM according to claim 2,
wherein
the foil comprises a connection strip, in particular an L-shaped connection strip, or respectively, the further foil comprises a further connection strip, in particular an L-shaped further connection strip,
the plurality of sensors, or respectively the further plurality of sensors, is electrically connected to separate components of the GPM through the connection strip, or respectively the further connection strip,
the connection cables, or respectively the further connection cables, are routed from the connection strip, or respectively the further connection strip, to the plurality of sensors, or respectively the further plurality of sensors, and
individual sensors of the plurality of sensors or of the further plurality of sensors can be accessed through the connection strip, or respectively through the further connection strip.

5. The GPM according to claim 4,
characterized in that the connection strip and the further connection strip are detached from the cover sheet, wherein the foil and the further foil are arranged in such a way on the cover sheet that the connection strip is substantially arranged on the further foil and that the further connection strip is substantially arranged on the foil, wherein the connection strip and the further connection strip are bent away from the further foil, or respectively from the foil, in particular at substantially 90 degrees with respect to the cover sheet.

6. The GPM according to claim 4,
wherein the connection strip and the further connection strip are laterally displaced to one another.

7. The GPM according to claim 4,
wherein at least one of the connection strip and the further connection strip is inserted into a reception slot of the separate components of the GPM, in particular into a reception slot of a PCB comprising at least one of a processing unit and a controlling unit.

8. The GPM according to claim 1,
wherein at least one of the sensor arrangement and the further sensor arrangement are placed between the cover sheet and the power emission means.

9. The GPM according to claim 1,
wherein at least one of the sensor arrangement and the further sensor arrangement is placed on the opposite side of the cover sheet with respect to the power emission means, wherein the cover sheet comprises a hole through which at least one of the connection strip and the further connection strip pass.

10. The GPM according to claim 1,
wherein the cover sheet has a cover sheet spatial extent, and the foil and the further foil have a foil spatial extent and a further foil spatial extent respectively, wherein the ratio of
foil spatial extent to cover sheet spatial extent, or
foil spatial extent plus further foil spatial extent to cover sheet spatial extent, is smaller than 0.9, in particular smaller than 0.5.

11. The GPM according to claim 1,
wherein the power emitted by the power emission means is substantially emitted through an emission area, and the
foil, or
foil plus further foil,
are at least as large as the emission area and are placed in the emission area.

12. The GPM according to claim 1,
wherein at least one of the plurality of sensors and the further plurality of sensors are embodied as loop sensors and arranged in two-dimensional arrays on the foil, or respectively on the further foil.

13. The GPM according to claim 1,
wherein at least one of:
the sensors and connection cables and
the further sensors and further connection cables are printed in layers on at the foil, or respectively further foil, and at least one isolation layer is printed on the foil, or respectively at least one further isolation layer is printed on the further foil.

14. The GPM according to claim 1,
wherein the GPM comprises a drive-over ramp, wherein the cover sheet is inserted on all sides into a recess of the drive-over ramp, wherein the cover sheet is in particular attached to the drive-over ramp by a tongue-and-grooves attachment mechanism, and wherein the cover sheet is in particular non-planar and comprises a bent section close to the drive-over ramp.

15. A method of producing a GPM according to claim 1, comprising printing a plurality of sensors and connection cables on the foil, in particular using screen printing of electrically conductive ink, in particular at least one of silver ink and copper ink.
